(19) United States
(12) Patent Application Publication
(10) Pub. No.: US 2002/0141703 A1
(43) Pub. Date: Oct. 3, 2002

(54) Loss compensating optical splitter

(76) Inventors: L. Wayne Sanderson, Fayetteville, TN (US); Jack L. Hayes, Madison, AL (US)

Correspondence Address: LANIER FORD SHAVER & PAYNE, P O BOX 2087, HUNTSVILLE, AL, 35804, US

(21) Appl. No.: 09/818,975

(22) Filed: Mar. 27, 2001

(51) Int. Cl. G02B 6/42

(52) U.S. Cl. 385/39

(57) ABSTRACT

An apparatus for compensating for optical loss includes a plurality of optical fibers joined to form a plurality of output ports and a fiber junction. A signal amplification device is positioned between the fiber junction and each of the plurality of output ports to communicate with the plurality of optical fibers. An optical transmission signal entering the input port of the apparatus is equally divided at the fiber junction and guided by separate optical fibers toward each of the output ports. Each signal amplification device communicates with the fibers to amplify the optical signals as they pass between the fiber junction and the output ports to compensate for the coupling and other losses experienced by the optical signals due at least in part to the use of the apparatus itself.

### BACKGROUND OF THE INVENTION

1. Field of the Invention

The present invention relates generally to the field of components for use in optical systems and networks, and more particularly to fiber optic components which divide optical signals among two or more output ports.

While the present invention has a number of uses in the field of fiber optics, it is particularly well suited for compensating for optical signal losses associated with the use of optical couplers, such as optical splitters used to discriminate between light of different wavelengths in an optical communication system.

2. Technical Background

In fiber optics, the term, “coupler” generally has a special meaning. A coupler generally connects three or more fiber ends (or optical devices such as detectors and transmitters). It is therefore distinct from connectors and splices which join two fiber ends, or a fiber with a light emitter or detector. This distinction is much more important in fiber optics than in electronics due, in part, to the way signals travel in fibers.

Because optical signals differ from electrical signals, they are transmitted and coupled differently. Unlike an electrical voltage, an optical signal is not a potential, but instead, a flow of signal carriers (photons). Thus, unlike current, an optical signal does not flow through the receiver on its way to ground. Instead, it stops there, and is absorbed by a detector. As a result, multiple fiber-optic receivers cannot be placed in series optically as the first receiver would absorb all of the signal. Accordingly, if an optical signal is to be divided between two or more output ports, the ports must be in parallel. Because the signal is not a potential, the entire signal cannot be delivered to all of the ports, but instead, must be divided between them in some way, reducing its magnitude.

This limits the number of terminals that can be connected to a passive fiber-optic coupler which merely splits up the input signal. After some maximum number of output ports is exceeded, there is generally not enough signal to go around (i.e., to be detected reliably with a low enough bit-error rate or high enough signal-to-noise ratio for the application). This division of power typically limits one transmitter to sending signals to tens of receivers, unless of course, amplifiers or repeaters are used to increase those numbers.

In early fiber-optic systems that carried signals between only pairs of points, fiber-optic couplers were limited in their application. Today, however, many communication applications such as local area networks (LANs) require the connection of many terminals. At each point where a device is connected to the network, the signal must be split into at least two parts—one to be passed along the network, and the other sent to the device. Generally speaking, this may be done in numerous ways. One way is to divide the optical signal at each connection, with part of the signal going to the device, and the rest continuing around the network. This is typically inefficient as coupler losses accumulate around the ring. Another way is to send signals to a central multi-port coupler, which distributes output to all terminals. Couplers are also crucial in Wavelength-Division Multiplexing (WDM) applications. In such applications, couplers are needed to separate or combine signals, usually at different wavelengths, being sent through the same fiber. Light of different wavelengths traveling through the same fiber does not generally interact strongly enough to affect signal transmission. In WDM applications, couplers are used to combine light signals from different sources at the input and separate them at the output.

As mentioned briefly above, most couplers are passive optical devices, which divide signals among two or more output ports. For such passive couplers, the total output power can be no more than the input power. From the viewpoint of each output device, the coupler exhibits a characteristic loss, equal to the ratio (in decibels) of output to that device to total input power. Thus, the equal division of an input signal between two output ports causes a loss of approximately 3 dB. Any additional loss above this theoretical minimum loss is known as excess loss. In the general case of a coupler with one input and many outputs, the total output, summed over all ports, equals input power minus excess loss. Thus, splitting an optical signal among two or more outputs in a passive coupler means that each output has less power than the input. In a perfect coupler, these would be the only losses experienced by the signal, and the sum of the outputs would equal the input. The theoretical perfect coupler, however, does not exist. In traditional couplers, an excess loss is given by taking the ratio of the total output to the input, and is usually given in decibels according to the following equation:

EXCESS LOSS (dB)=−10 log (output power/input power)

In a 1×2 coupler, for example, input power Pᵢₙ is applied to the input fiber and output power P₀₁ and P₀₂ appear at one or both of the output fibers. Accordingly, excess loss (dB) for a 1×2 coupler is defined as −10 log ((P₀₁+P₀₂)/Pᵢₙ). The excess loss is considered power wasted in the coupler.

Another significant source of attenuation resulting from the use of couplers occurs at the connections. At the connections, light is reflected rather than transmitted. The resulting losses associated with these reflections are typically on the order of 0.5 dB or less. These connection losses are in addition to the losses discussed above and contribute further to transmission signal degradation.

As a result of these shortcomings, optical system designers must give due consideration to the number and placement of couplers in system design. Failing to do so may otherwise result in insufficient signal transmission power at the receiving devices in the network. Due to this shortcoming, attempts have been made to compensate for the losses associated with the use of passive optical couplers. These “active devices” serve the same function as couplers, but do, however, generate or amplify light.

Active couplers are essentially special-purpose repeaters that drive both a terminal device and an output fiber. Generally speaking, a receiver detects the input light generating an electronic signal that then passes to decoding electronics. The decoder separates signals intended for that terminal from those intended for the rest of the network and generates two electronic outputs—one for the terminal device, and the second for an optical transmitter. The transmitter then produces a signal that drives the next fiber segment. This approach is used in some LANs including networks known as Fiber Distributed Data Interface (FDDI) networks. Another approach has been to add an optical amplifier to the transmission line either before, after, or before and after the coupler ports. Amplifiers used in such configurations are intended to make up for lost power to the extent necessary to raise signal strength to meet receiver requirements. Yet another approach has been the introduction of planer waveguide technology into fiber optic systems. The field is often called integrated optics, as it allows many optical devices to be integrated on a single substrate. Losses, however, are extremely high as the substrate material is a poor waveguide. Generally speaking, all of these approaches are expensive to implement and maintain, and the gains intended to compensate for the coupler losses are difficult to control.

What is needed therefore, but currently unavailable in the art, is a fiber optic coupler that can accurately compensate for the theoretical and excess losses that result from an optical signal being divided among two or more output ports. More specifically, there is a need for a loss compensating fiber optic coupler that can efficiently and effectively discriminate between light at different wavelengths in a fiber optic network without diminishing the optical signal strength. In some embodiments, the fiber optic coupler of the present invention should preferably be capable of such compensation over a broad wavelength range, and in some instances have the ability to increase signal strength such that output power exceeds the input power entering the coupler. Such a device should be simple and inexpensive to manufacture, require low power, be easy to maintain, and non-intrusive in operation. It is to the provision of such a device and method that the present invention is primarily directed.

### SUMMARY OF THE INVENTION

One aspect of the present invention relates to an apparatus for compensating for optical loss. The apparatus of the present invention includes a plurality of optical fibers joined to define a plurality of output ports and a fiber junction. A signal amplification device is positioned between the fiber junction and each of the plurality of output ports to communicate with the plurality of optical fibers.

Another aspect of the present invention is directed towards an apparatus for compensating for optical loss. The apparatus of the present invention includes a plurality of optical fibers joined to form an input port, a coupled region, a fiber junction, and a plurality of output ports. A signal amplification device is positioned between the fiber junction and each of the plurality of output ports to communicate with the plurality of optical fibers in such a way that an optical signal passing between the fiber junction and each output port is amplified.

A further aspect of the present invention relates a method of compensating for optical loss. The method of the present invention includes the steps of receiving an optical signal through the input port of an optical splitter which includes a fiber junction, a first output port, and a second output port, and dividing the optical signal at the fiber junction such that a first signal portion is directed toward the first output port and a second signal portion is directed toward the second output port. The method further includes the step of amplifying the first and second signal portions with a signal amplification device positioned between the fiber junction and each output port while the signal portions are traveling between the fiber junction and the output ports.

An additional aspect of the present invention is directed to a process of manufacturing an optical signal loss compensating device. The process of the present invention includes the steps of joining at least two optical fibers to form a coupled region, a fiber junction, and a plurality of output ports, and positioning a signal amplification device between each output port and the fiber junction. A device made by this process is an additional aspect of the present invention.

In yet another aspect, the present invention is directed to a loss compensating optical communication system. The loss compensating optical communication system of the present invention includes a transmitter, a receiver, a transmission line positioned between and cooperating with the transmitter and receiver to carry an optical signal from the transmitter to the receiver, and a loss compensating optical splitter communicating with the transmission line. The loss compensating optical splitter includes a plurality of optical fibers joined to define a fiber junction, and a plurality of output ports. A signal amplification device is positioned between the fiber junction and each output port to provide a source of amplification to the optical signal carried through the plurality of fibers.

The loss compensating optical apparatus and method of compensating for coupler losses in optical communication systems of the present invention provides a number of advantages over other splitters and methods currently known in the art. Heretofore, the use of optical couplers such as passive optical splitters in communication networks resulted in a characteristic loss of at least 3 dB. Generally speaking, when optical couplers such as splitters are used in optical networking environments, coupling losses, fiber losses, splice losses, and connector losses, to name a few, drive the signal loss value much higher. Depending upon system requirements, the minimum characteristic loss alone can adversely affect communications over a network in which a splitter is installed. Because the loss compensating optical splitter and method of the present invention amplifies the optical transmission signal as it passes between the fiber junction of the splitter and the output port in accordance with the present invention, the characteristic loss (>3 dB) and other losses associated with the use of splitters may be compensated for before the optical transmission signal leaves the output port or ports of the splitter. As a result, the loss compensating optical splitter of the present invention is essentially “invisible” to the fiber optic network in which it is installed.

In addition, the loss compensating optical splitter of the present invention may be manufactured as a single component so that it may be installed and used in a number of different fiber optic networks, often without modification. The signal amplification device, preferably one or more semiconductor optical amplifiers, one or more Light Emitting Diodes (LEDs), or other signal amplification source, associated with the loss compensating optical splitter may be used to provide different amounts of amplification or gain between the fiber junction and output ports of the loss compensating optical splitter of the present invention. Thus, the same loss compensating optical splitter, for example, may be installed in a fiber optic system requiring compensation for only approximately 3 dB of loss, or it may be installed, for example, in a system requiring compensation for about 3.4 dB of loss. This represents a significant advancement over fiber optic devices and systems presently in service, which attempt to compensate for coupler losses by providing amplification to the system either immediately before or immediately after the coupler. In such systems, different amplification or gain components would likely be installed for the various couplers/splitters employed in the network as the amplifier components would likely be specifically designed to meet the system requirements for the various couplers.

Yet another advantage of the loss compensating optical splitter and method of the present invention is realized by fiber optic system designers. Because the losses associated with the couplers of the present invention are compensated for by the splitters themselves, system designers need not include coupler losses in their system calculations when designing a particular optical system or network. As a result, system design is easier, less costly, and less time consuming.

Still another advantage of the loss compensating optical splitter and method of the present invention is the cost savings associated with its use. More specifically, the apparatus used to facilitate amplification in the splitter of the present invention, preferably a semiconductor optical amplifier, or LED, is relatively inexpensive to manufacture and use, requires low power, is consistent in operation, and is generally not susceptible to malfunctioning.

A further advantage of the loss compensating optical splitter and method of the present invention relates to flexibility. The loss compensating optical splitter of the present invention may be designed to provide amplification over a broad range of wavelengths. For example, a single loss compensating optical splitter manufactured in accordance with one or more embodiments of the present invention may be capable of amplifying optical signals operating at any wavelength within a wavelength range from about 1280 nm to about 1630 nm. Depending upon, among other things, the choice of fiber material, the number of semiconductor optical amplifiers or LEDs used in the splitter, and the composition of the semiconductor optical amplifiers used, (or the number and type of LEDs used), amplification over other broad wavelength ranges is also possible.

These and additional features and advantages of the invention will be set forth in the detailed description which follows, and in part will be readily apparent to those skilled in the art from that description or recognized by practicing the invention as described herein.

It is to be understood that both the foregoing general description and the following Detailed Description are merely exemplary of the invention and are intended to provide an overview or framework for understanding the nature and character of the invention as it is claimed. The accompanying drawings are included to provide further understanding of the invention and are incorporated in and constitute a part of this specification. The drawings illustrate various embodiments in the invention and together with the description serve to explain the principles and operation of the invention.

### BRIEF DESCRIPTION OF THE DRAWING FIGURES

FIG. 1 schematically depicts a first preferred embodiment of the loss compensating optical splitter in accordance with the present invention.

FIG. 2 is a perspective view of a section of the active fiber region of the loss compensating optical splitter schematically depicted in FIG. 1.

FIG. 3 is a cross-sectional view taken along lines 3—3 of the active fiber region depicted in FIG. 2.

FIG. 4 schematically depicts a second preferred embodiment of the loss compensating optical splitter in accordance with the present invention.

FIG. 5 schematically depicts a third preferred embodiment of the loss compensating optical splitter in accordance with the present invention.

FIGS. 6A-6D schematically illustrate (in cross-section) a preferred process for manufacturing the loss compensating optical splitter depicted in FIG. 5.

FIG. 7 is a partial cross-sectional view of one optical fiber taken along lines 7—7 in FIG. 5 illustrating the positioning and operation of the semiconductor optical amplifier in accordance with the present invention.

FIG. 8 schematically depicts a fourth preferred embodiment of the loss compensating optical splitter in accordance with the present invention.

FIG. 9 is a partial cross-sectional view of one optical fiber taken along lines 9—9 in FIG. 8 illustrating the positioning and operation of a plurality of semiconductor optical amplifiers arranged in series in accordance with the present invention.

FIG. 10 is a schematic illustration of a loss compensating optical communication system in accordance with the present invention.

### DETAILED DESCRIPTION OF THE PREFERRED EMBODIMENTS

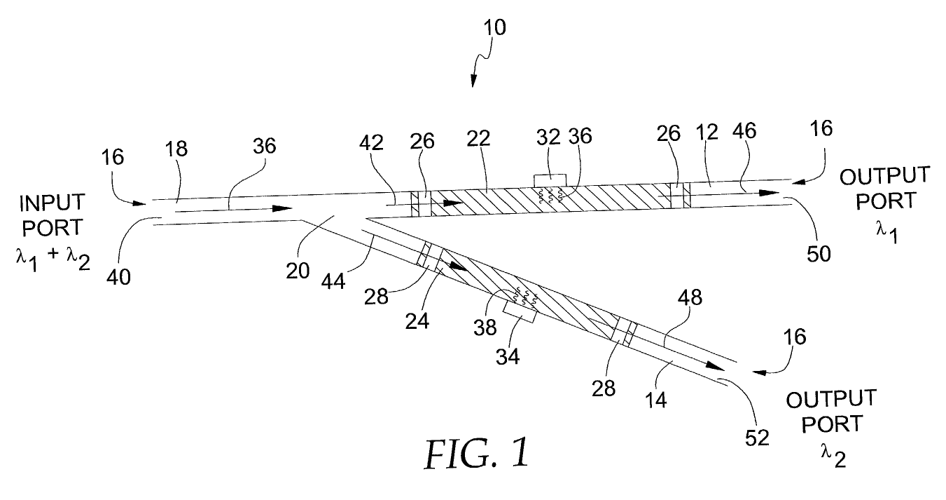

Reference will now be made in detail to the present preferred embodiments of the invention, examples of which are illustrated in the accompanying drawings. Wherever possible, the same reference numerals will be used throughout the drawing figures to refer to the same or like parts. An exemplary embodiment of the loss compensating optical splitter of the present invention is shown schematically in FIG. 1, and is designated generally throughout by reference numeral 10.

In accordance with the present invention for compensating for optical coupling losses includes a plurality of optical fibers 12 and 14 joined to define a plurality of ports 16, a coupled region 18, and a fiber junction 20 where optical fibers 12 and 14 are joined to form a single wave guide or coupled region 18. In the first preferred embodiment of the present invention, each optical fiber 12 and 14 includes an active fiber region 22 and 24, respectively. Active fiber region 22 is preferably bounded by optical filters 26 such as, but not limited to, low pass filters, and band pass filters, while active fiber region 24 is preferably bounded by optical filters 28 such as, but not limited to, low pass filters, and band pass filters. In both instances, photonic band gap devices or Fiber Bragg Gratings (FBGs) are the preferred filters. Those skilled in the art, however, will recognize that other devices which selectively allow the transmission of some wavelengths while reflecting others may be used in lieu of optical filters.

Each active fiber region 22 and 24 preferably includes a light amplifying dopant such as one or more of the elements known in the art as rare earth elements, Three such rare earth elements particularly well suited for providing the requisite amplification associated with loss compensating optical splitter 10 of the present invention are erbium, praseodymium, and ytterbium. When incorporated in active fiber region 22 and/or 24, any one or combination of these elements are capable of providing the necessary amplification to boost an optical transmission to a sufficient level to compensate for the characteristic loss, coupling losses, and other losses of transmission signal 30 power generally experienced by an optical transmission signal passing through fiber optic splitter 10. This being said, the preferred embodiments of the present invention will be described herein with reference to active fiber region 22 being doped with erbium while active fiber region 24 will be described as being doped with praseodymium, unless otherwise indicated. One skilled in the art will appreciate, however, that the specific percentages of any dopant incorporated in active fiber regions 22 and 24 will vary depending upon, among other things, the power and emission wavelength of the light sources such as Light Emitting Diode (LEDs) 32 and 34 selected for use with loss compensating optical splitter 10.

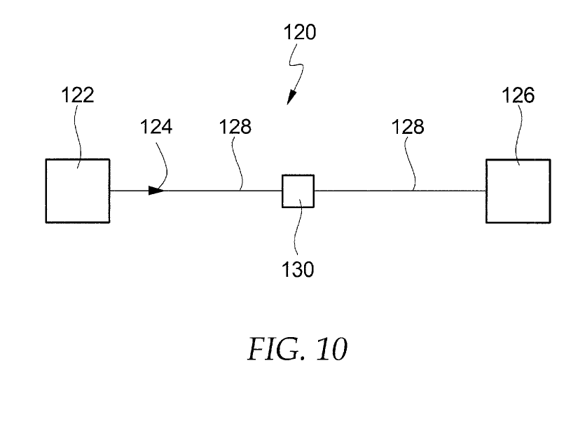

Generally speaking, the active ions of the erbium and praseodymium contained in active fiber regions 22 and 24 of loss compensating optical splitter 10 of the present invention are excited by pumped light 36 and 38 emitted by LED 32 and 34, respectively, in order to subsequently amplify optical transmission signal 30 supplied by a pump source (not shown), such as a laser. In the case of the 1×2 splitter depicted in FIG. 10 optical transmission signal 30 is received through input port 40 upstream of active fiber regions 22 and 24. Transmission signal 30 is guided through coupled region 18 and split, substantially equally, at fiber junction 20 as transmission signal 30 travels through optical splitter 10. As a result of coupling losses such as splitting losses, a weakened first signal 42 is guided through active fiber region 22 and a weakened second signal 44 is guided through active fiber region 24. When active fiber region 22 is doped with the rare earth element erbium, optical filters 26 bounding active fiber region 22 are preferably formed such that their wavelength band pass characteristics are selective at about the 1550 nm window. As a result, light operating in the 1550 nm window will pass into active fiber region 22 while other wavelengths generally will not. While weakened first signal 42 is traveling within active fiber region 22, LED 32 emits pumped light at approximately 980 nm or 1480 nm into active fiber region 22 to stimulate the erbium atoms to release their stored energy as additional light waves operating at the 1550 nm window. The additional light waves thus amplify or pump up the weakened first signal 42 passing through active fiber region 22 to compensate for the coupling losses and other losses.

When active fiber region 24 is doped with praseodymium, the optical filters 28 bounding active fiber region 24 are preferably formed such that their wavelength band pass characteristics are selective at about the 1300 nm operating window. As a result, only light operating at about 1300 nm will pass through active fiber region 24 while other wavelengths generally will not. While weakened second signal 44 is traveling within active fiber region 24, LED 34 emits pumped light at approximately 1047 nm into active fiber region 24 to stimulate the praseodymium atoms to release their stored energy as additional light waves operating at the 1300 nm window. The additional light waves thus amplify or pump up weakened second signal 44 as weakened second signal 44 passes through active fiber region 24 to compensate for the coupling losses and other losses. As a result, the light waves of amplified signals 46 and 48 will have substantially the same power when they exit active fiber regions 22 and 24 as they did when they constituted light wave 30. Accordingly, the light waves of amplified signals 46 and 48 exiting through output ports 50 and 52 will re-enter the transmission line (not shown) with substantially the same power and at substantially the same wavelength as they had when they entered input port 40. The loss typically associated with the light waves entering and traveling through splitter 10 is thus essentially compensated for.

If desired, loss compensating optical splitter 10 may provide sufficient amplification to provide optical signal gain in excess of the loss experienced by optical transmission signal 30. In such case, amplified signals 46 and 48 will exit output ports 50 and 52 and re-enter the transmission lines (not shown) with more power than they had when transmission signal 30 entered input port 40. Such a loss compensating optical splitter 10 may at least partially compensate for other losses not associated with the use of the splitter itself, such as, but not limited to, the loss in transferring light from the transmission source into the fiber, connector losses, splice losses, fiber losses, and fiber-to-receiver coupling losses, to name a few.

Optical fibers 12 and 14 of the present invention may be made of glass, plastic, plastic clad glass, or other specialty materials, such as, but not limited to, zirconium-based fluoride and indium-based fluoride compounds, and tellurite-based compounds. Generally speaking, preferred fiber 12 is a silica (Sio₂) based glass fiber which may be doped with germania (GeO₂) or some other suitable material(s). Preferred optical fiber 14 is a fluoride based fiber. While the present invention may be implemented more efficiently with single mode optical fiber, it is operative with multi-mode optical fiber as well. Further, while standard single mode fiber is generally manufactured to have a diameter of 125 μm and a core diameter ranging from about 9 μm to 11 μm, fibers having other diameters may be used, provided they can be adequately coupled without exhibiting excessive loss.

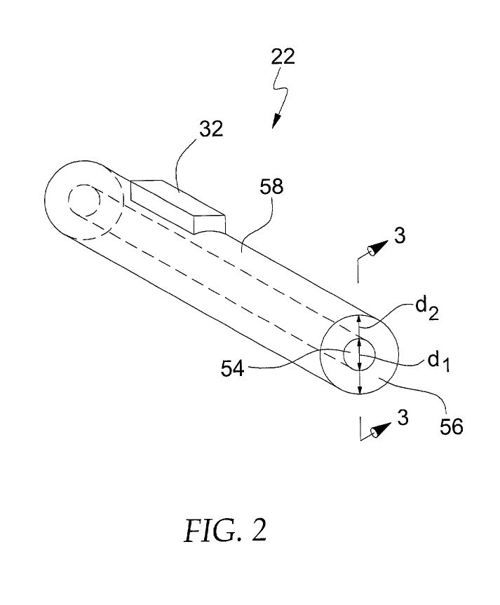

As shown more clearly in the perspective view of FIG. 2, a preferred embodiment of active fiber region 22 of the loss compensating optical splitter 10 of the present invention is preferably a core-clad optical fiber span having an axially extending central core region 54 bounded by a clad region 56 which has a lower index of refraction than that of core region 54. The refractive index of the core region 54 is higher than that of the cladding region 56 so that light passing through core region 54 will be substantially confined within core region 54 by total internal reflection. Those of skill in the art will recognize, however, that at least some light will be lost, causing attenuation of the signal when the optical signals are carried over long distances.

Core region 54 includes a core diameter d₁ and a total (core-clad) diameter d₂ which is preferably sized and shaped to substantially match the respective diameters of fibers 12 and 14 and transmission optical fibers (not shown). In addition, active fiber region 22 is preferably a SiO₂ based optical waveguide having its core region 54 doped with a light amplifying material or materials such as erbium. In a first preferred embodiment core region 54 is preferably doped with erbium in a sufficient quantity to provide the desired amplification to weakened first signal 42 passed through active fiber region 22. The erbium ions within core region 54 are preferably excited via side mounted LED 32 affixed along the length of active fiber region 22, the operation of which will be described in greater detail below.

Although the light source for the first preferred embodiment of the present invention is described as an LED 32, other light sources such as lasers, and in particular, Vertical Cavity Surface Emitting Lasers (VCSELs) may be used. Generally speaking, an LED 32 operating at a wavelength of approximately 980 nm or 1480 nm is the preferred excitation source for erbium. Other rare earth elements or combinations of rare earth elements will likely require light sources such as LED's or VCSELs which emit light at the necessary excitation wavelength(s) of the selected dopant or dopants.

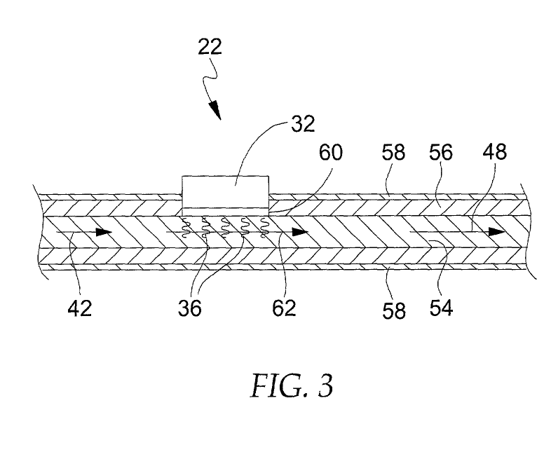

As will be readily apparent to those skilled in the art, and as shown in FIG. 3, active fiber region 22 may be coated with one or more protective layers 58 which are generally applied to increase total diameter d₂ to 125 μm (or some other standard size), and to increase the fiber strength and durability. Often, protective layer 58 is a plastic material, or in certain applications a titanium containing material. It will also be understood by those skilled in the art, that optical fibers 12 and 14, including active fiber region 22 and 24 may be manufactured using any of a number of the chemical vapor deposition (CVD) techniques, plasma techniques, or other optical fiber manufacturing techniques known in the art. Although not shown in detail, those skilled in the art will recognize that the discussion set forth above with respect to FIG. 2 is equally applicable to active fiber region 24, with the following exceptions. First, the preferred embodiment of active fiber region 24 is doped with praseodymium rather than erbium. As a result, LED 34, or other source of amplification, preferably operates at a wavelength of approximately 1047 nm. Moreover, for peak operating characteristics, optical fiber 14, and thus active fiber region 24 is preferably a fluoride based optical waveguide.

The operation of loss compensating optical splitter 10 of the present invention can be more clearly understood with reference to the cross-sectional view of active fiber region 22 depicted in FIG. 3. FIG. 3 illustrates the preferred positioning of LED 32 with respect to core region 54 and clad region 56. Although not required, the light emitting portion of LED 32 is preferably positioned adjacent core region 54 of active fiber region 22. Such placement substantially maximizes the amount of emitted near infra-red (IR) light or pumping light 36 entering core region 54 of active fiber region 22.

LED 32 is preferably affixed adjacent core region 54 following removal of protective layer(s) 58 and cladding region 56 in a location where LED 32 is to be positioned. Removal of protective layer(s) 58 and cladding region 56 may be effected by etching or other techniques commonly known in the art. LED 32 is then preferably adhered adjacent core region 54 with an adhesive such as an epoxy 60 which is substantially transparent to light emitted by LED 32 at the pumping wavelength, or by techniques such as ultra-violet (UV) heating. When an index-matching material such as a transparent epoxy is used, a transparent gel or solid having a refractive index close to that of the fiber core region 54 is preferred. When practical, the etched portion of active fiber region 22 may be sized and shaped such that it firmly holds LED 32 in position adjacent core region 54.

LED 32 is a low cost, wide emission, light source that is highly reliable. Another advantage of LED 32 is that its output power varies directly with the input current, thus providing for direct modulation. As a result, adequate power can be generated by LED 32, and that power can be controlled so that non-linear effects and/or distortion in the fiber can be minimized. Although LED 32 is a preferred light source for active fiber region 22, it is to be understood that other light sources such as semiconductor lasers may be employed in accordance with other embodiments of the invention. As mentioned previously, LED 34 will have different operating characteristics since active fiber region 24 is preferably doped with praseodymium.

In operation, and as illustrated in FIG. 3, weakened first signal 42 enters active fiber region 22 of loss compensating optical splitter 10 as a weakened transmission signal, due in part to the various coupling losses. IR pump light 36 emitted by LED 32 into core region 54 of active fiber region 22 causes the rare earth element atoms, such as erbium atoms in the fiber, to become excited. In the case of erbium, pump light 36 is emitted from LED 32 at approximately 980 nm or 1480 nm, the specific wavelengths necessary to excite the erbium atoms. The pump light 36 emitted at 980 nm or 1480 nm stimulates the erbium atoms to release their stored energy as additional light waves 62 operating at a wavelength window from about 1520 nm to about 1560 nm. Additional light waves 62 thus amplify or pump up the weakened first signal 42 as it makes a single pass through active fiber region 22, thus compensating for coupling losses and other losses experienced by the transmission signal. When amplified signal 46 exits output port 50 of loss compensating optical splitter 10, the signal strength is substantially identical to, and may possible be stronger than transmission signal 30 prior to its entry into input port 40 of loss compensating optical splitter 10. When the rare earth element in core region 54 is erbium, gains of approximately 20 dB to 40 dB may be realized at an operating wavelength of approximately 1550 nm. Moreover, output powers may exceed 100 mW. Similar gains may be realized when active fiber region 24 is doped with praseodymium or co-doped with erbium/ytterbium and/or other rare earth elements or their combinations at their respective operating wavelengths.

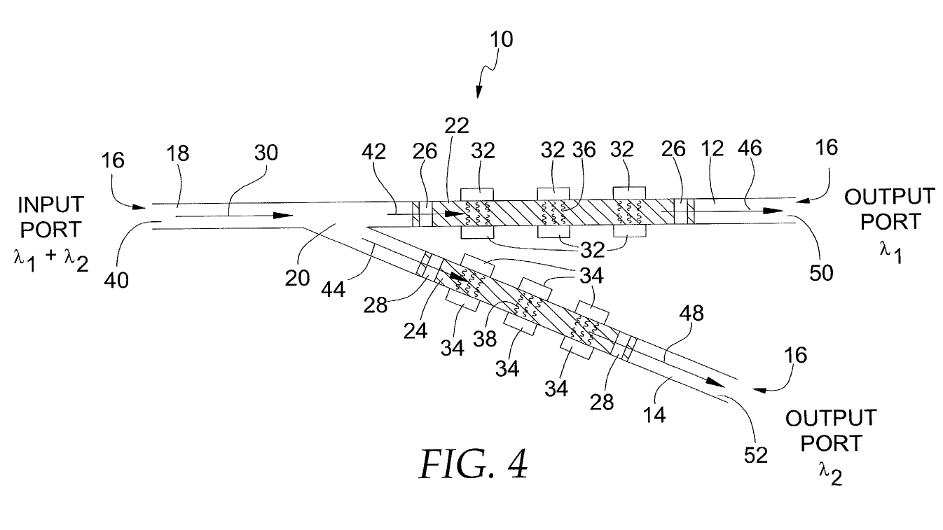

FIG. 4 depicts a second preferred embodiment of the loss compensating optical splitter 64 in accordance with the present invention. Loss compensating optical splitter 64 is substantially identical to loss compensating optical splitter 10 of the present invention with the exception that loss compensating optical splitter 64 includes a plurality of light sources such as LEDs 32 and 34 spaced laterally and circumferentially along active fiber regions 22 and 24, respectively. Loss compensating optical splitter 64 is preferably formed by “fusing” two optical fibers, one of which is preferably pre-doped with erbium and the other with praseodymium, or some other rare earth element(s). Optical fibers 12 and 14 are preferably heated and drawn so that core regions 54 (FIG. 3) of optical fibers 12 and 14 essentially combine into a single core. It will be understood by those skilled in the art, however, that optical fibers 12 and 14 may be coupled using other conventional methods known in the art such as core-to-core splicing. Once fused, loss compensating optical splitter 64 defines a plurality of ports 16, a coupled fiber region 18, and a fiber junction 20. Active fiber regions 22 and 24 are preferably configured and doped as described above with reference to FIG. 1, however, other rare earth elements such as ytterbium, thulium, neodymium, or other rare earth elements and combinations thereof may be used in lieu of erbium and praseodymium. When other rare earth elements are used, those skilled in the art will recognize that optical filters 26 and 28 will provide wavelength band pass characteristics selective for the dopant used in active fiber regions 22 and 24, respectively. Moreover, LEDs 32 and 34 or other amplifying devices will be selected or designed to emit in the infrared at wavelengths compatible with the selected dopants.

When active fiber region 22 is doped with erbium and active fiber region 24 is doped with praseodymium, pump light 36 operating at approximately 980 nm or 1480 nm for erbium doped active fiber region 22 and pump light 38 operating at approximately 1047 nm for praseodymium doped active fiber region 24 does not, however, pass through filters 26 and 28. Instead, the pump light 36 and 38 remains within active fiber region 22 and 24 and thus cannot pass through to output ports 50 and 52 where it would otherwise be received as system noise. The LED 32 and 34 leads (not shown) are preferably terminated such that a proper DC voltage may be applied in order to emit the pumping light into the doped core regions 54 at the appropriate power and wavelength. When properly terminated, loss compensating optical splitter 64 can effectively compensate for characteristic coupler losses and other losses associated with signal splitting through fiber junction 20. When doped with the rare earth elements erbium and praseodymium, loss compensating optical splitter 64 provides the desired compensation for losses over the usable wavelengths near the 1540 nm window in fiber 12 and the 1300 nm window in fiber 14.

The amount of loss compensation may be controlled by altering the amount and type of rare earth element doping of active fiber regions 22 and 24, and the amount of current supplied to LEDs 32 and 34. The plurality of LEDs 32 and 34 provide redundancy in the event that one or more LEDs 32 and/or 34 fail, and also maximize the amount of pump light 36 and 38 available to facilitate amplification. In addition, multiple LEDs 32 and 34 provide for more accurate amplification control. Moreover, multiple LEDs 32 and 34 may be required along the length of active fiber regions 22 and 24 since the light launched by LEDs 32 and 34 experiences multiple reflections and is thus attenuated over a limited distance. Accordingly, the range of effectiveness of each pumping LED may be improved by diffusing the LED 32 and 34 light as it impinges on the fiber core. Positioning multiple LEDs 32 and 34 along and around each active fiber region 22 and 24 will thus facilitate excitation of the erbium and praseodymium atoms throughout active fiber region 22 and 24, respectively.

It will be apparent to those skilled in the art that various modifications and variations can be made to the first and second preferred embodiments without departing from the spirit and scope of the invention. For example, although the present invention has been shown and described with reference to a 1×2 splitter, the present invention is equally applicable to 2×2 couplers, and the like. In addition, active fiber regions 22 and 24 of splitter 10 and 64 of the present invention may preferably be co-doped with a plurality of rare earth elements. In such cases, the various rare earth elements will likely require different pumping wavelengths for their sources of excitation. Whereas erbium generally requires an excitation source such as an LED 32 operating at a wavelength of about 980 nm or 1480 nm, ytterbium will likely require a pumping wavelength other than 980 nm or 1480 nm to provide amplification near the 1600 nm window. Thus, to provide amplification across the broadest wavelength range, it may be preferable to provide a splitter 10 or 64 that is co-doped with two or more rare earth elements with a plurality of pumping light sources, such as LEDs 32 and 34 and/or other amplification devices capable of delivering pumping light at each of the wavelengths necessary to excite the respective rare earth elements. A 1.047 μm-Nd: YLF laser may be one such other pumping source. Thus it is intended that the present invention as described with reference to the first and second preferred embodiments of the present invention cover the modifications and variations of this invention provided they come within the scope of the appended claims and their equivalents.

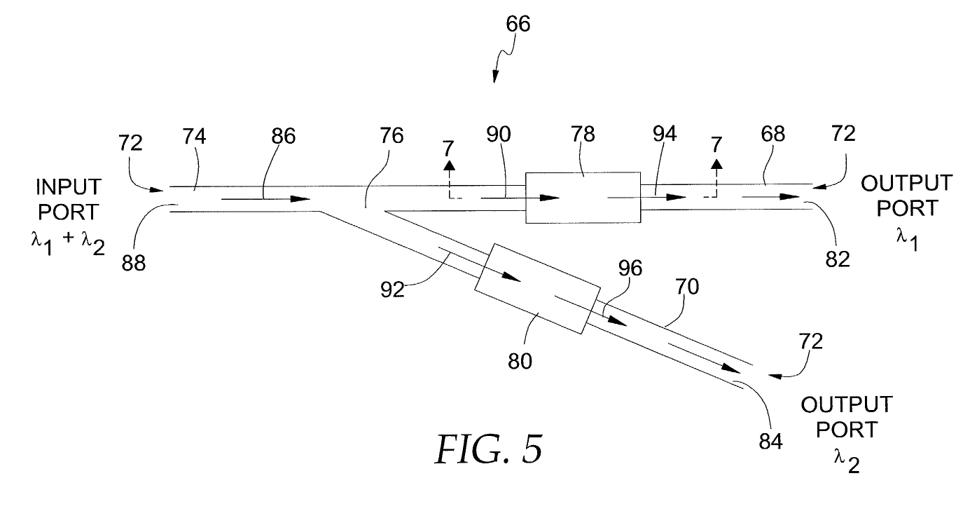

A third embodiment of the loss compensating optical splitter of the present invention is shown schematically in FIG. 5, and is designated generally throughout by reference numeral 66. In accordance with the invention, the present invention for compensating for optical losses includes a plurality of optical fibers 68 and 70 joined to define a plurality of ports 72, a coupled region 74, a fiber junction 76, and a semiconductor optical amplifier 78 and 80 positioned between fiber junction 76 and output ports 82 and 84, such as, but not limited to, a semiconductor laser amplifier. Those skilled in the art, however, will recognize that other devices that amplify an optical signal may be used in lieu of semiconductor optical amplifiers 78 and 80.

In operation, an optical signal 86 is received through an input port 88 of loss compensating optical splitter 66 and is guided through a coupled region 74 to fiber junction 76 where signal 86 is split essentially equally between optical fibers 68 and 70. In addition to any optical loss already experienced by optical signal 86, additional loss is incurred when optical signal 86 passes through and is split at fiber junction 76. Accordingly, a first weakened signal 90 travels through fiber 68 and enters semiconductor optical amplifier 78 and a second weakened signal 92 travels through fiber 70 and enters semi-conductor optical amplifier 80. As weakened signals 90 and 92 pass through semiconductor optical amplifiers 78 and 80 they are amplified, preferably by stimulated emission. Amplified signals 94 and 96 then exit semiconductor optical amplifiers 78 and 80, respectively. Amplified signals 94 and 96 then exit output ports 82 and 84 of splitter 66 to continue along the optical network.

Generally speaking, semiconductor optical amplifiers 78 and 80 of loss compensating optical splitter 66 of the present invention at least compensate for the loss experienced by optical signal 86. As a result, the light waves of weakened signals 90 and 92 will at least have substantially the same power when they exit semiconductor optical amplifiers 78 and 80 as amplified signals 94 and 96, as they did when they entered splitter 66 as combined signal 86. Accordingly, the light waves of optical signals 94 and 96 exiting through output ports 82 and 84 will re-enter the transmission lines (not shown) with substantially the same power and at substantially the same wavelength as they had when they entered input port 88. The loss typically associated with the light waves entering the splitter, and thereafter being split, is thus essentially compensated for. More preferably, loss compensating optical splitter 66 may provide sufficient amplification to provide optical signal gain in excess of the loss experienced by optical signals 86, and 90 and 92. In such case, amplified signals 94 and 96 will exit output ports 82 and 84 and re-enter the transmission lines (not shown) with more power than optical signal 86 had when it entered input port 88. Such a loss compensating optical splitter 66 may also at least partially compensate for other losses not associated with the use of the splitter itself, such as, but not limited to, the loss in transferring light from the transmission source into the fiber, connector losses, splice losses, fiber losses, and fiber-to-receiver coupling losses, to name a few.

Optical fibers 68 and 70 of the present invention may be made of glass, plastic, plastic clad glass, or other specialty materials, such as, but not limited to, zirconium-based fluoride and indium-based fluoride compounds, and tellurite-based compounds. Generally speaking, preferred optical fiber 68 is a silica (Sio₂) based glass fiber which may be doped with germania (GeO₂) or some other suitable material(s). Preferred optical fiber 70 may be a fluoride based fiber. While the present invention may be implemented more efficiently with single mode optical fiber, it is operative with multi-mode optical fiber as well. Further, while standard single mode fiber is generally manufactured to have a total diameter of 125 μm and a core diameter ranging from about 9 μm to 11 μm, fibers having other diameters may be used, provided they can be adequately coupled, in accordance with the present invention, without exhibiting excessive loss.

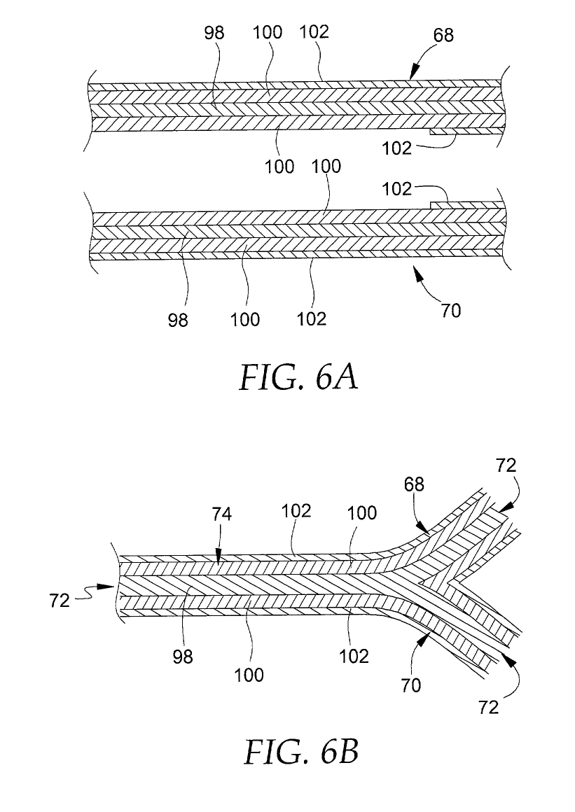

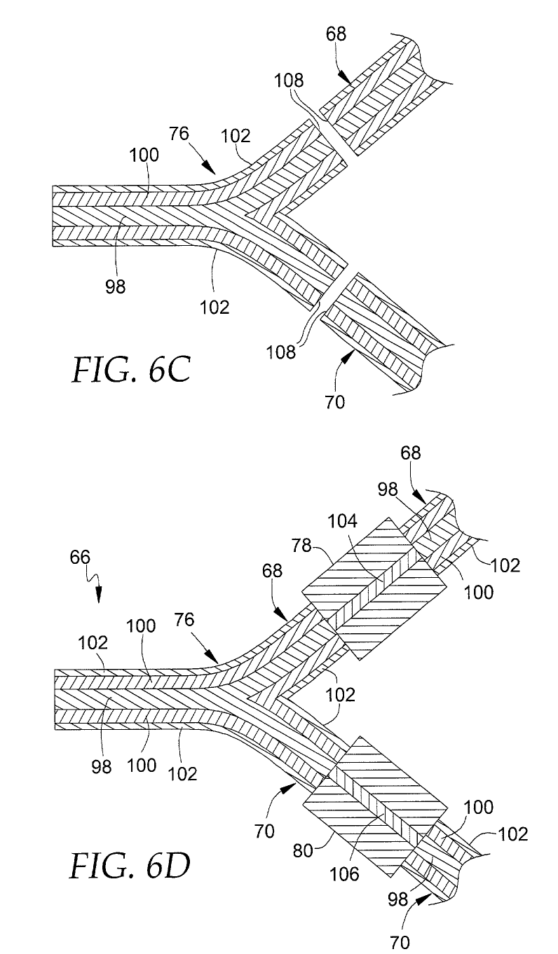

FIGS. 6A through 6D (shown in cross-section) depict a preferred process for manufacturing an optical signal loss compensating device in accordance with the present invention. As shown in FIG. 6A, at least two optical fibers 68 and 70, each having a core region 98, a cladding region 100, and a protective sheath 102 (typically a plastic material) are positioned adjacent one another. A portion of protective sheath 102 is preferably removed from each optical fiber 68 and 70 to facilitate formation of a coupled region 74 (FIG. 6B). As shown in FIG. 6B, optical fibers 68 and 70 are then preferably brought together where the sheath 102 has been removed and are melted or fused via a heat source (not shown) to form a coupled region 74, a fiber junction 76, and a plurality of ports 72. More preferably, prior to fusing, some or all of the cladding region 100 is removed from that area of each fiber 68 and 70 where protective sheath 102 has been removed. In addition, fibers 68 and 70 are preferably pulled during the fusing step to create a tapered region where light can be transferred between the substantially joined core regions 98.

The resulting optical splitter 66 is then preferably cut or spliced (as shown in FIG. 6C) radially through each fiber 68 and 70. As shown in FIG. 6D, semiconductor optical amplifiers 78 and 80, each having an active layer 104 and 106, respectively, are positioned between the cut ends 108 of fibers 68 and 70. In a preferred embodiment, semiconductor optical amplifiers 78 and 80 are bonded to the cut ends 108 such that active layers 106 and 108 are substantially aligned with core regions 98 of fibers 68 and 70.

As will be described in greater detail below, the ends of semiconductor optical amplifiers 78 and 80 are preferably coated with an anti-reflective coating material prior to being bonded to cut ends 108. Moreover, one or more additional semiconductor optical amplifiers may be positioned between cut ends 108. In such an embodiment, the multiple semiconductor optical amplifiers are preferably aligned and bonded end to end in series such that each active layer is substantially aligned with the active layer of adjacent semiconductor optical amplifiers.

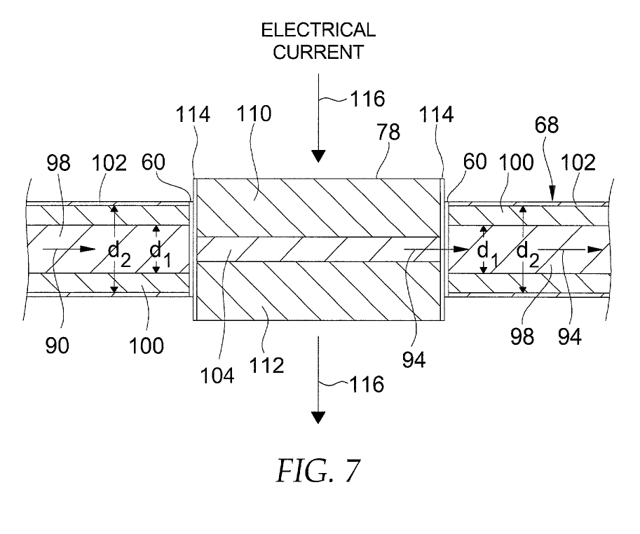

As shown more clearly in the partial cross-sectional view depicted in FIG. 7, a preferred embodiment of loss compensating optical splitter 66 of the present invention preferably includes a core-clad optical fiber span having an axially extending central core region 98 bounded by a clad region 100 which has a lower index of refraction than that of core region 98. Like fibers 68 and 70 discussed above, the refractive index of the core region 98 is higher than that of the cladding region 100 so that light passing through core region 98 will be substantially confined within core region 98 by a phenomenon known in the art as total internal reflection. Those of skill in the art will recognize, however, that at least some light will be lost, causing attenuation of the signal when, among other things, the optical signals are carried over long distances.

The core-clad fiber span includes a core diameter d₁ and a total (core-clad) diameter d₂. and is preferably formed from an SiO₂ based optical waveguide having core region 98 which may be doped with a light amplifying material or materials such as one or more rare earth elements. As will be readily apparent to those skilled in the art, the core-clad fiber span may be coated with one or more protective sheaths 102 which are generally applied to increase total diameter d₂ to 125 μm (or some other standard size), and to increase the fiber strength and durability. Often, protective sheath 102 is a plastic material, or in certain applications a titanium containing material. It will also be understood by those skilled in the art, that optical fibers 68 and 70 (to include the core-clad fiber span and coupled region 74) may be manufactured using any of a number of the chemical vapor deposition (CVD) techniques, plasma techniques, or other optical fiber manufacturing techniques known in the art.

The operation of loss compensating optical splitter 66 of the present invention may also be more clearly understood with reference to the partial cross-sectional view of the core-clad fiber span depicted in FIG. 7. FIG. 7 illustrates the preferred positioning of semiconductor optical amplifier 78 with respect to core region 98 and clad region 100. Semiconductor optical amplifier 78 is preferably positioned between cut ends 108 such that core regions 98 are substantially aligned with active layer 104 of semiconductor optical amplifier 78. The ends of semiconductor optical amplifier 98 are then preferably adhered adjacent cut ends 108 with an adhesive such as an epoxy 60 which is substantially transparent to light delivered through cut ends 108 at the pumping wavelengths, or affixed to cut ends 108 by other techniques such as ultra-violet (UV) heating. When an index-matching material such as a transparent epoxy is used, a transparent gel or solid having a refractive index close to that of the core regions 98 is preferred.

Semiconductor optical amplifier 78 such as, but not limited to, a semiconductor diode laser preferably includes at least two substrate materials 110 and 112 with an active layer 104 positioned therebetween. Unlike traditional laser sources which have reflective ends to keep light bouncing back and forth within active layer 104, semiconductor optical amplifier 78 is preferably coated at its ends with anti-reflective coatings 114. While a semiconductor optical amplifier 78 having an active layer 104 only a few micrometers across and a fraction of a micrometer high is operative with the present invention, it is preferable that active layer 104 is matched as closely as possible to the size and shape of core regions 98 at the cut ends 108. Such size matching limits the loss of light, and thus optical signal, otherwise resulting from beam spreading or divergence. Although semiconductor optical amplifier 78 is a preferred source of amplification for active splitter 66, it is to be understood that other amplification sources such as other diode lasers, as well as other amplifying devices may be employed in accordance with other embodiments of the present invention.

The primary compositions used in diode laser light sources, and thus semiconductor optical amplifiers 78 and 80 are variations on the standard III-V semiconductor compounds that can be fabricated on substrates of gallium arsenide or indium phosphide. Generally speaking, Ga(₁₋ₓ)AlₓAS on GaAs is a preferred material for operation in the 780 nm to 850 nm wavelength range, IN_{0.73}GA_{0.27}ASO_{0.58}P_{0.42} on InP is a preferred material for operation at the 1310 nm window, and In_{0.58}Ga_{0.42}As_{0.9}P_{0.1} on InP is a preferred material for operation in the 1550 nm window. Other InGaAsP mixtures may be used for other wavelengths between about 1100 nm and 1600 nm. As those skilled in the art will recognize, the need for the proper band-gap in the active layer and for interatomic spacings reasonably close to those of readily available substrates (a restriction that has been relaxed recently in the development of strained-layer structures) are important design considerations. As mentioned previously and as depicted in FIG. 7, because the ends of semiconductor optical amplifier 78 are coated to suppress reflection of light back into semiconductor optical amplifier 78, weakened optical signal 90 is directed into active layer 104, where stimulated emission amplifies it. Amplified signal 94 then emerges from the opposite end of semiconductor optical amplifier 78 where it is collected in the core region of fiber 68 and thereafter the core region of an optical transmission line (not shown). Ideally, none of the signal light is reflected back into semiconductor optical amplifier 78. Provided the core region of the optical transmission line is sized to substantially match the size of the active layer 104, transfer losses will be minimal.

In operation, and as illustrated in FIG. 7, an optical signal enters core region 98 of loss compensating optical splitter 66 as a weakened optical signal 90, due in part to the various coupling losses. An electrical current 116 is set running through semiconductor optical amplifier 78 in order to excite electrons which can then fall back to the non-excited ground state and thus give out photons (particles of light). The light is emitted when something (e.g. an electron in a semiconductor) drops from a higher energy level to a lower one, releasing the extra energy. Generally speaking, the electrons remain at a high energy level until the requisite amount of energy needed for emission is introduced. In this case, photons from weaker signal 90 have the requisite energy to stimulate the electron in the upper energy level to drop to the lower one, thus emitting its energy as light of the same wavelength. The result is a second identical photon, and the process is generally known in the art as stimulated emission. Thus, as weaker signal 90 is directed onto active layer 104, stimulated emission occurs as weaker signal 90 passes through active layer 104. The addition of photons results in an amplified signal 94 exiting the opposite end of semiconductor optical amplifier 78. Amplified signal 94 is then collected within core region 98 adjacent the exit end of semiconductor optical amplifier 78.

Amplification preferably occurs as the optical signal makes a single pass through active layer 104, thus compensating for the transmission signal 86 coupling losses and other losses. When amplified transmission signal 94 exits output port 82 of loss compensating optical splitter 66, the signal strength is substantially identical to, and may be stronger than optical signal 86 prior to its entry into input port 88 of loss compensating optical splitter 66. When the composition of active layer 104 is InGaAsP, gains of approximately 25 dB to 30 dB may be realized at an operating wavelength of approximately 1310 nm-1550 nm. Moreover, output powers may exceed 10 dBm. Generally speaking, active layer 106 of semi-conductor optical amplifier 80 will differ in composition from that of active layer 104 so that amplification at a different operating wavelength window can be accomplished through the leg of the splitter not shown in FIG. 7.

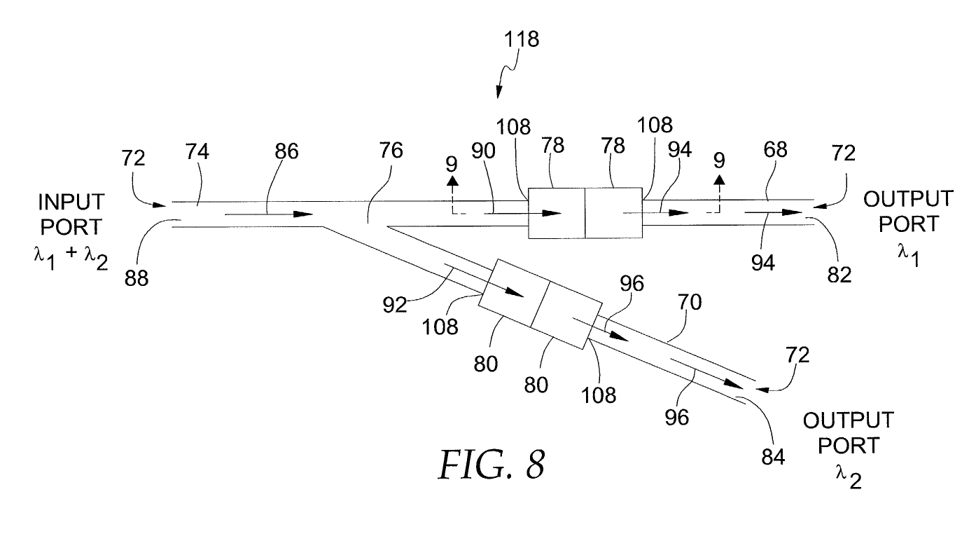

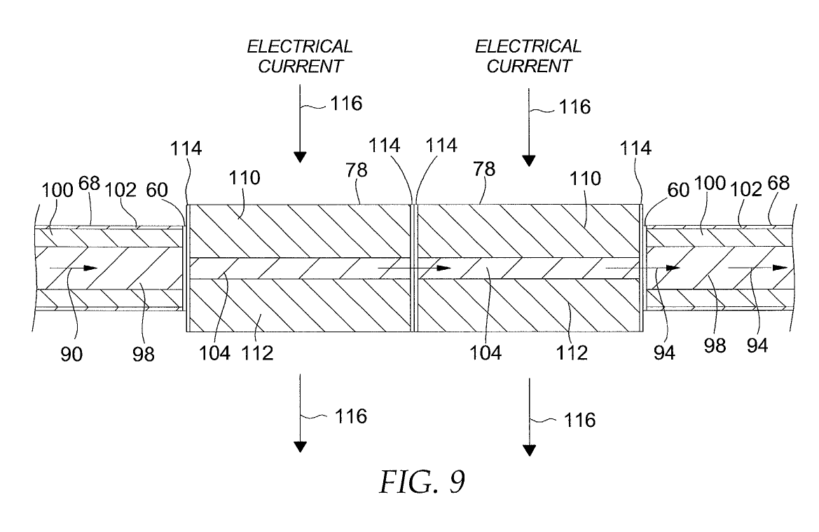

FIGS. 8 and 9 depict a fourth preferred embodiment of loss compensating optical splitter 118 of the present invention. Loss compensating optical splitter 118 is substantially identical to loss compensating optical splitter 66 of the present invention with the exception that loss compensating optical splitter 118 includes a pair of semiconductor optical amplifiers 78 and 80, such as semiconductor diode lasers, preferably aligned end to end in series between cut ends 108 of each fiber 68 and 70. Loss compensating optical splitter 118 is preferably formed by “fusing” two optical fibers, as is commonly known in the art. Optical fibers 68 and 70 are preferably heated and drawn so that core regions 98 of each optical fiber 68 and 70 essentially combine into a single core having a tapered coupled region 74. It will be understood by those skilled in the art, however, that optical fibers 68 and 70 may be coupled using other conventional methods known in the art, such as core-to-core splicing. Once fused, loss compensating optical splitter 118 preferably defines a plurality of ports 72, a coupled region 74, a fiber junction 76 and a pair of optical fibers 68 and 70. Each fiber 68 and 70 is then cut or spliced to form a plurality of cut ends 108 between which are positioned a pair of semiconductor optical amplifiers 78 and 80, preferably in series. The additional semiconductor optical amplifiers 78 and 80 provide additional amplification or gain to weakened signals 90 and 92 directed into lead semiconductor optical amplifiers 78 and 80. As a result, weakened optical signals 90 and 92 may pass into active layers 104 and 106 of the first or lead semiconductor optical amplifiers 78 and 80 where they are amplified by stimulated emission, continue through active layers 104 and 106 of second semiconductor optical amplifiers 78 and 80 where they are further amplified by stimulated emission, and thereafter exit active layers 104 and 106 of second semiconductor optical amplifiers 78 and 80 as amplified transmission signals 94 and 96, which is substantially collected in core regions 98 of fibers 68 and 70 adjacent the exit ends of semiconductor optical amplifier 78 and 80.

Loss compensating optical splitter 118 can effectively compensate for characteristic coupler losses and other losses associated the use of splitter 118 in an optical system. When semiconductor optical amplifiers 78 and 80 are formed from the proper compositions, loss compensating optical splitter 118 may provide the desired compensation for losses over the usable wavelengths near the 1540 nm window through one fiber 68 and may provide the desired compensations for losses over the usable wavelengths near another operating window, such as the 1300 nm window through the other fiber 70. The amount of loss compensation may be controlled by altering semiconductor optical amplifier 78 and 80 composition as described above, and by increasing or decreasing the number of semiconductor optical amplifiers arranged in series.

FIG. 10 illustrates a loss compensating optical communication system 120 in accordance with the present invention. System 120 preferably includes at least a transmitter 122 for generating an optical transmission signal 124, a receiver 126 remote from transmitter 122 for receiving and interpreting the transmitted optical transmission signal 124, a transmission line 128 such as long haul optical fiber positioned between and cooperating with the transmitter 122 and receiver 126 to carry optical transmission signal 124 from the transmitter 122 to the receiver 126, and at least one loss compensating amplification device 130 (such as any of the devices such as LED's or semiconductor optical amplifiers discussed above) communicating with the transmission line 128. When system 120 is a long haul fiber network, the network will typically incorporate other components such as amplifiers, repeaters, wavelength division multiplexers (WDMs) and demultiplexers, optical isolators, and other optical components.

It will be apparent to those skilled in the art that various modifications and variations can be made to the present invention without departing from the spirit and scope of the invention. For example, although the present invention as described above with reference to preferred embodiments 3 and 4 has been shown and described with reference to a 1×2 splitter, the present invention is equally applicable to 2×2 couplers, and the like. In addition, the first and second preferred embodiments of the invention may be manufactured substantially in accordance with FIGS. 6A-6D. One skilled in the art will recognize that splicing of the optical fibers, however, is not required for the first and second preferred embodiments as LEDs are used as the pumping source rather than semiconductor optical amplifiers. Thus it is intended that the present invention cover the modifications and variations of this invention provided they come within the scope of the appended claims and their equivalents.

What is claimed is:

1. An apparatus for compensating for optical loss, said apparatus comprising:
a plurality of optical fibers joined to define a plurality of output ports and a fiber junction; and
a signal amplification device positioned between the fiber junction and each of the plurality of output ports to communicate with said plurality of optical fibers.

2. The apparatus of claim 1 wherein said signal amplification device comprises a semiconductor optical amplifier.

3. The apparatus of claim 1 wherein said signal amplification device comprises a plurality of semiconductor optical amplifiers.

4. The apparatus of claim 1 further comprising an active fiber region including a dopant residing within said optical fibers between the fiber junction and each output port, and wherein said signal amplification device comprises at least one light source coupled to the active fiber region to emit light into the active fiber region at a wavelength and power sufficient to excite the dopant.

5. An apparatus for compensating for optical loss, said apparatus comprising:
a plurality of optical fibers joined to form an input port, a coupled region, a fiber junction, and a plurality of output ports; and
a signal amplification device positioned between the fiber junction and each of the plurality of output ports to communicate with said plurality of optical fibers such that an optical signal passing between the fiber junction and each of the output ports is amplified.

6. The apparatus of claim 5 wherein said signal amplification device comprises a semiconductor optical amplifier.

7. The apparatus of claim 5 wherein said signal amplification device comprises a plurality of semiconductor optical amplifiers.

8. The apparatus of claim 5 further comprising an active fiber region including a dopant residing within said optical fibers between the fiber junction and each output port, and wherein said signal amplification device comprises at least one light source coupled to the active fiber region to emit light into the active fiber region at a wavelength and power sufficient to excite the dopant.

9. The apparatus of claim 8 wherein one of said active fiber regions comprises erbium and wherein the other of said active fiber regions comprises a dopant other than erbium.

10. The apparatus of claim 8 wherein said at least one light source comprises a plurality of LEDs.

11. A method of compensating for optical loss, said method comprising the steps of:
receiving an optical signal through an input port of an optical splitter, said optical splitter comprising a fiber junction, a first output port, and a second output port;
dividing the optical signal at the fiber junction such that a first portion of the optical signal is directed toward the first output port and a second signal portion is directed toward the second output port; and
amplifying the first and second signal portions of the optical signal with a signal amplification device positioned between the fiber junction and each output port while the signal portions are traveling between the fiber junction and the output ports.

12. The method of claim 11 wherein said signal amplification device comprises a semiconductor optical amplifier and wherein said amplifying step includes the step of boosting the first and second signal portions via stimulated emission.

13. The method of claim 11 wherein said signal amplification device comprises a LED and wherein said optical splitter further comprises a dopant containing active fiber region between the fiber junction and each output port, said amplifying step comprising the step of emitting light from said LED into the active fiber region at a wavelength and power sufficient to excite the dopant as the first and second signal portions are passed through the active fiber regions.

14. A process of manufacturing an optical signal loss compensating device, said process comprising the steps of:
joining at least two optical fibers to form a coupled region, a fiber junction, and a plurality of output ports; and
positioning a signal amplification device between each output port and the fiber junction.

15. The process of claim 14 further comprising the step of radially splicing said at least two optical fibers between said fiber junction and said plurality of output ports prior to said positioning step.

16. The process of claim 15 wherein said signal amplification device comprises a semiconductor optical amplifier and wherein said positioning step comprises placing the semiconductor optical amplifier between the spliced ends of said at least two optical fibers.

17. A device made by the process of claim 14.

18. The process of claim 14 wherein said at least two optical fibers each comprise an active fiber region, and wherein said signal amplification device comprises a LED, said positioning step comprising the step of mounting the LED adjacent the active fiber region.

19. The process of claim 18 wherein said LED comprises a plurality of LEDs, said positioning step comprising the step of mounting said plurality of LEDs adjacent the active fiber region.

20. A loss compensating optical communication system comprising:
a transmitter;
a receiver;
a transmission line positioned between and cooperating with said transmitter and said receiver to carry an optical signal from said transmitter to said receiver; and
a loss compensating optical splitter communicating with said transmission line and comprising a plurality of optical fibers joined to define a fiber junction and a plurality of output ports, said splitter further including a signal amplification device positioned between the junction and each output port to provide a source of amplification to the optical signal carried through the plurality of fibers.
